(19) United States
(12) Patent Application Publication
(10) Pub. No.: US 2006/0225359 A1
(43) Pub. Date: Oct. 12, 2006

(54) Railroad sliding car door seal

(76) Inventor: David L. Tuma, Bellevue, NE (US)

Correspondence Address: Edward M. Keating;Cook, Alex, McFarron, Manzo, Cumming & Mehler, Ltd, Suite 2850, 200 W. Adams Street, Chicago, IL, 60606, US

(21) Appl. No.: 11/078,744

(22) Filed: Mar. 11, 2005

(51) Int. Cl. E05C 7/06

(52) U.S. Cl. 49/370; 49/410; 49/116

(57) ABSTRACT

A rail car door opening sealing mechanism for use on rail cars having a main door and an auxiliary door which come together in an aligned abutting relationship to close the door opening. The door opening sealing mechanism has compressible elongated tubular gaskets of resilient composition installed on the remote vertical edges of the main and auxiliary doors and a tubular gasket of similar material installed on the converging edge of one of the doors which gaskets are compressed when the doors are closed. Brush seals are positioned above and below the door opening to provide weather resistant seals when the main and auxiliary doors are closed.

### BACKGROUND OF THE INVENTION

Railroad box cars are built with large side openings each of which is closed by a pair of horizontally sliding doors. The doors of such a pair of doors are conventionally referred to as a main door and an auxiliary door. This arrangement of sliding doors does not provide complete protection against leakage around the peripheries of the doors caused by rain, snow, wind and other weather conditions. Attempts to prevent leakage around these doors have included the provision of overlapping main and auxiliary doors equipped with tubular gaskets installed around all edges of the main door and around three of the four edges of the auxiliary door. An example of such a construction can be found in U.S. Pat. No. 5,581,951.

Other door sealing arrangements have been provided on a sliding door which has pivotal mounts so that the sliding door can be tightened towards the rail box car door opening in a manner that seals positioned at the top, bottom and sides of the sliding door are compressed. An example of this construction can be found in U.S. Pat. No. 6,591,761.

In other attempts to control leakage, plug doors have been provided with compressible gaskets around the perimeter of the door. An example of such a construction can be found in U.S. Pat. No. 5,467,558.

### SUMMARY OF THE INVENTION

This invention is directed to a sealing arrangement for sliding railroad car doors which can be installed on newly constructed railcar doors and can be adapted to existing sliding railcar doors.

An object of this invention is a sealing arrangement for sliding railroad car doors which is less expensive than providing gaskets around most of the side edges of a pair of sliding doors or providing gasketed plug doors.

Another object of this invention is a sealing arrangement for sliding railroad car doors which does not require a mechanism to move the doors inwardly and outwardly relative to the railcar door opening for sealing and unsealing of the doors.

An additional object of this invention is a sealing arrangement for sliding railroad car doors which uses commercially available tubular compression seals.

Yet another object of this invention is a sealing arrangement for sliding railcar doors which uses conventional plastic sealing brushes.

A further object of this invention is a sealing arrangement for sliding railcar doors which is adaptable for top hung sliding doors.

Other object of the invention will be found in the following specification, claims and drawings.

### BRIEF DESCRIPTION OF THE DRAWINGS

The invention is illustrated more or less diagrammatically in the following drawings wherein:

FIG. 1 is a side elevational view of a pair of top hung sliding doors of a railroad car incorporating the novel aspects of this invention;

FIG. 2 is a partial horizontal cross-sectional view of the railcar and doors of FIG. 1 with portions broken away for clarity of illustration;

FIG. 3 is an enlarged, partial view of the top portion of the door sealing arrangement of this invention with parts omitted and others shown in cross-section for clarity of illustration;

FIG. 4 is an enlarged partial cross-sectional view of the lower portion of the door sealing arrangement of this invention with some parts omitted for clarity of illustration;

FIG. 5 is an enlarged partial view of the auxiliary door with its main door engaging vertical seal in its uncompressed condition;

FIG. 6 is an enlarged partial cross-sectional view of the auxiliary door with its remote edge vertical seal shown in its sealing condition; and

FIG. 7 is an enlarged partial cross-sectional view of the sealing gasket carried by the auxiliary door and compressed in sealing engagement with the main door.

### DESCRIPTION OF THE PREFERRED EMBODIMENT

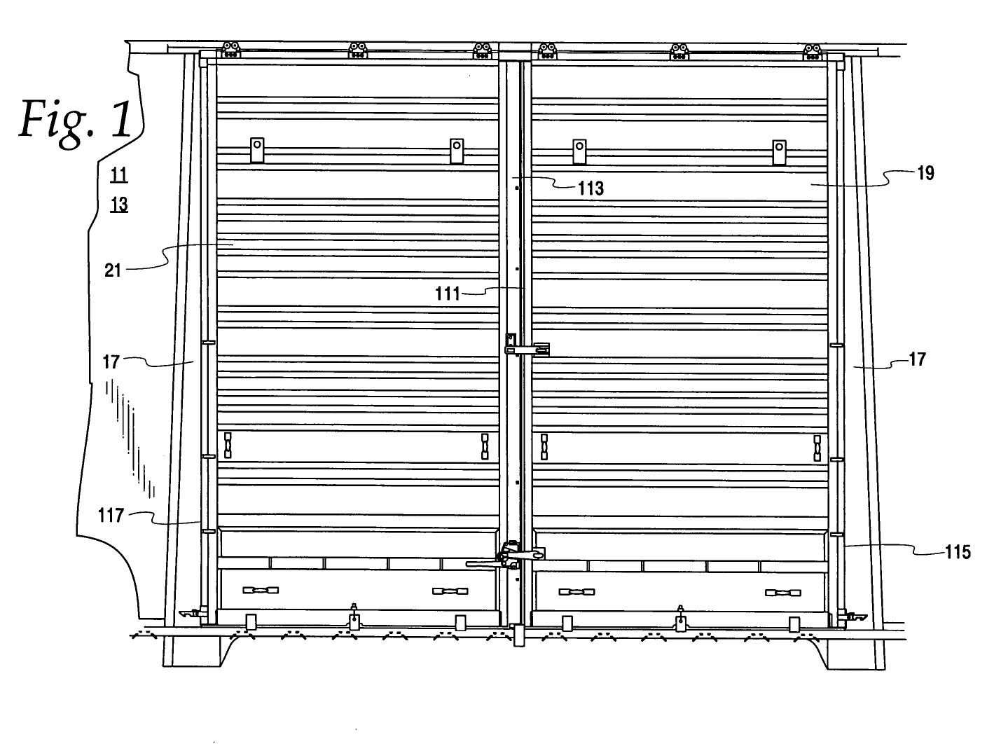

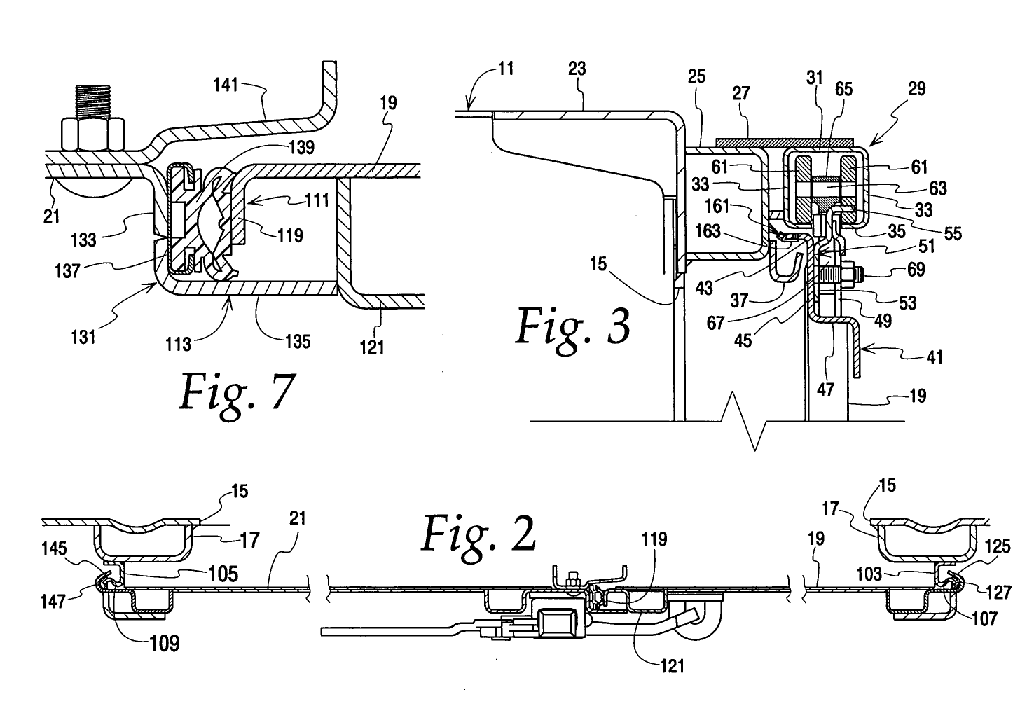

FIG. 1 of the drawings shows a portion of a railroad car 11 having a side wall 13 equipped with a door opening 15 (FIG. 2) bounded by door posts 17. A main door 19 and an auxiliary door 21 are slidably mounted on the side wall 13 of the car to provide access to and to close the door opening 15. The abutting relationship and sealing of the doors is shown in FIG. 2 of the drawings.

FIG. 3 of the drawings shows a sliding arrangement for the main door 19 which is identical to the arrangement for the auxiliary door 21 which is not shown for clarity of illustration. The railroad car 11 includes a car top side plate 23 to which is attached a channel beam 25. A support plate 27 mounts a top door roller track box 29 to the channel beam 25. The track box 29 is formed with a top wall 31 which attaches to the support plate 27. The roller track box 29 includes side walls 33, each of which have inturned flanges 35. A trough 37 is attached to the channel beam 25 near the lower edge thereof and extends over the door opening 15.

A top frame 41 is attached to the main door 19. This top frame is of irregular shape and includes a horizontally extending top portion 43 formed integrally with a vertical portion 45 and a lower horizontal portion 47. An upstanding leg 49 is supported on the lower horizontal portion 47 of the top frame 41 in a position in which it is spaced from and parallel to the vertical portion 45 of the top frame 41. A door safety retainer 51 is formed with a vertical portion 53 positioned against the vertical portion 45 of the top frame 41. The safety retainer also includes an outwardly extending finger 55 which extends into the door roller track box 29 between the inturned flanges 35.

The door top support rollers 61 are shown most clearly in FIG. 3 of the drawings where they are supported and ride on the inturned flanges 35 of the roller track box 29. The rollers are mounted on an axle 63 seated in a hub 65 which is part of a hub support arm 67. The hub support arm 67 extends downwardly between the upstanding leg 49 and the vertical portion 53 of the safety retainer 51. A bolted fastener 69 extends through openings (not shown) in a vertical portion 45 of the door top frame 41, the vertical portion 53 of the safety retainer 51 and the upstanding leg 49 to fasten the hub support arm 67 and its rollers 61 to the top door frame 41.

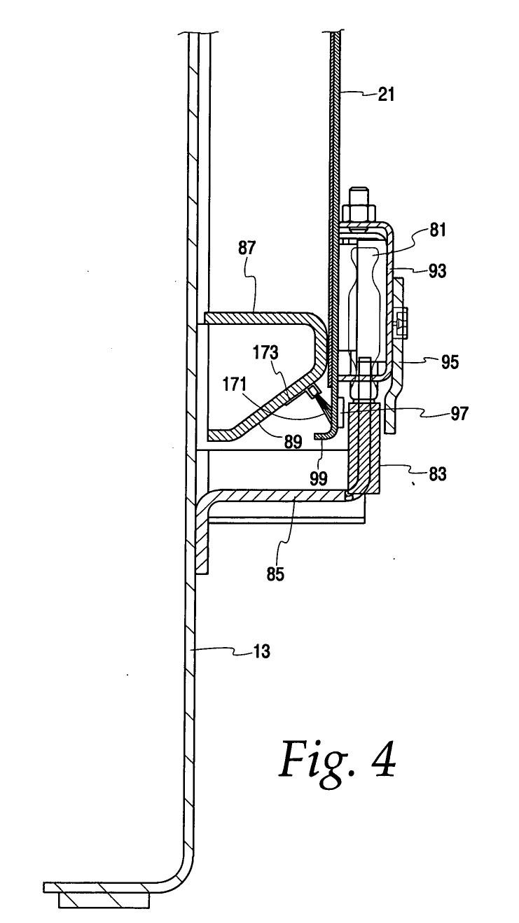

The door bottom guide roller 81 is shown in detail in FIG. 4 of the drawings. The guide roller 81 rolls on a door track 83 which is supported on a track support bracket 85 attached to the side wall 13 of the railcar. The guide roller 81 guides the door against a threshold 87 which threshold includes an inclined lower surface 89. The guide roller is located in a protective housing 93 which has a retainer plate 95 downwardly extending on the outer side thereof. A door buffer strip 97 is located inwardly of the door track 83. The door 13 includes an inwardly turned bottom lip 99.

The location and arrangement of the sealing apparatus of this invention is shown most clearly in FIGS. 1, 2, 5, 6 and 7 of the drawings. As seen in FIG. 2 of the drawings, the main door post strip 103 is mounted on a door post 17 adjacent one side of the door opening 15. The auxiliary door post strip 105 is mounted on the opposite door post 17. The main door post strip 103 has a gasket engaging finger 107 and the auxiliary door post strip 105 has a gasket engaging finger 109. The main door 19 has a converging end 111 and the auxiliary door 21 has a converging end 113 as shown most clearly in FIG. 7 of the drawings. The main door has a remote end 115 and the auxiliary door has a remote end 117 as shown in FIG. 1. The converging end 111 of the main door has a gasket engaging flange 119 extending from a vertical door reinforcing channel 121. At the remote end of the main door 19, a reversely turned gasket flange 125 engages a D-shaped gasket 127 retained in the gasket flange 125 as shown in FIG. 2 of the drawings. The gasket 127 may be formed of a resilient composition gasket material.

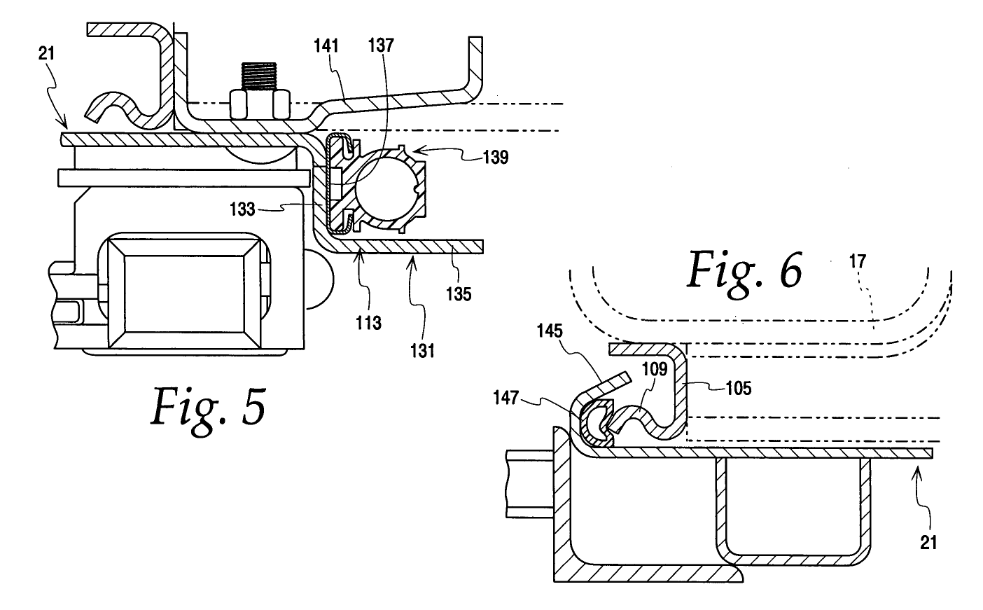

The converging end 113 of the auxiliary door 21 is shown in enlarged detail in FIGS. 5 and 7 of the drawings. The converging end 113 includes an L-shaped flange 131 formed as part of the remote end 113 which has a shorter base leg 133 and a longer stop leg 135. A metal gasket retainer 137 is attached to the shorter base leg 133 and supports a hollow tubular compressible gasket 139 formed of a resilient composition material. Also located at the converging end of the auxiliary door is a door closing guide 141.

FIG. 7 of the drawings shown the sealing compression of the gasket 139 when the main and auxiliary doors are moved towards each other to the door closing position. The gasket engaging flange 119 of the main door 19 engages the gasket 139 compressing it against gasket retainer 137 mounted on the shorter base leg 133 of the L-shaped flange 113 of the auxiliary door 21. The amount of compression of the gasket is limited by the engagement of the stop leg 135 on the L-shaped flange 131 of the auxiliary door 21 with the vertical door reinforcing channel 121 of main door 19. The D-shaped gasket 127 at the remote end of the main door 19 is compressed by engagement with the gasket engaging finger 125 of the main door post strip 103 as shown in FIG. 2. When the auxiliary door 21 has been moved to its door closing position shown in FIG. 7 of the drawings, a D-shaped gasket 147 of a resilient composition material held in a reversely turned gasket flange 145 located at the remote end 117 of the auxiliary door is engaged by the gasket engaging finger 109 of the auxiliary door post strip 105 as shown in FIG. 6 of the drawings.

The sealing of the top of a door 19 or 21 is most clearly shown in FIG. 3 of the drawings where a continuous nylon brush 161 is supported by a bracket 163 which is attached to the top horizontal portion 43 of the door top frame 41. The top horizontal portion 43 fits over the trough 37 above the door and the bristles of the brush 161 engages the side of the channel beam 25 located over the door when either of the doors is moved to its closed position. The same continuous nylon brushes are installed at the tops of the doors 19 and 21.

The weatherproofing of the lower portion of a door is shown in detail in FIG. 4 of the drawings in which a continuous nylon brush 171 is mounted to a bracket 173 attached to the inclined lower surface 89 of the threshold 87. The brush 171 engages the door immediately above the bottom ledge 99 of a door 19 or 21 when the door is moved to its closed position.

The provision of seals 127, 139 and 147 mounted on the remote and converging vertical ends of the doors 19 and 21 when used with the continuous brush seals 161 and 171 at the tops and bottoms of the doors 19 and 21 establish a weatherproof perimeter around the door opening 15.

1. A rail car door opening sealing mechanism for use on rail cars having an opening, a main door and an auxiliary door which doors come together in an aligned abutting relationship to close said opening, said sealing mechanism comprising;
an elongated tubular gasket of resilient composition material mounted in a position to be compressed between said main door and said auxiliary door when said doors come together to close said opening,
a D-shaped elongated tubular gasket adapted to be mounted each of remotely located ends of said main door and said auxiliary door to be compressed when said doors are moved together to close said opening, and
at least one brush seal adapted to be located at the top and bottom of each of said main and auxiliary doors with said at least one brush seal having bristles adapted to be positioned to engage a rail car and said rail car doors when said doors come together to close said opening with said gaskets and said brush seals providing a weather resistant seal surrounding said opening.

2. The rail car door sealing mechanism of claim 1 in which each of said elongated tubular gaskets is mounted on one of said main and said auxiliary doors and each elongated tubular gasket is engaged by an element of said other door when said doors come together to close said opening.

3. The rail car door sealing mechanism of claim 2 in which said elongated tubular gasket is mounted on said auxiliary door and said gasket engaging element is located on said main door.

4. The rail car door sealing mechanism of claim 3 in which said elongated tubular gasket is supported by a gasket retainer.

5. The rail car door sealing mechanism of claim 1 in which each of said D-shaped elongated tubular gaskets is adapted to be supported in a reversely turned gasket flange formed on each of said doors.

6. The rail car door sealing mechanism of claim 5 in which each of said D-shaped elongated tubular gaskets is adapted to be compressed by engagement with a gasket engaging finger mounted on each of said rail doors when said doors come together to close said opening.

7. The rail car door sealing mechanism of claim 1 in which said brush seal located at the bottom of said door opening is mounted on said car and said bristles engage said doors.

8. The rail car door sealing mechanism of claim 1 in which said brush seal located at the bottom of said door opening is mounted on said car and said bristles engage said doors.

9. A rail car having a side wall, an opening in said side wall, a main door and an auxiliary door closing said opening, and a sealing mechanism for said opening, said sealing mechanism comprising:
an elongated tubular gasket of resilient composition material positioned to be compressed between said main door and said auxiliary door when said doors are moved together to close said opening,
a D-shaped elongated tubular gasket mounted on each of remotely located ends of said main door and said auxiliary door where it is compressed when said doors are moved together to close said opening, and
at least one brush seal located at the top and at least one brush seal located at the bottom of said main and auxiliary doors with said at least one brush seal having bristles positioned to engage said rail car and said main and auxiliary doors when said doors come together to close said opening with said gaskets and said brush seals providing a weather resistant seal surrounding said opening.

10. The rail car of claim 9 in which each said elongated tubular gasket is mounted on one of said main and said auxiliary doors and each said elongated tubular gasket is engaged by an element of said other door when said doors come together to close said opening;

11. The rail car of claim 10 in which said elongated tubular gasket is mounted on said auxiliary door and said gasket engaging element is located on said main door.

12. The rail car of claim 11 in which said elongated tubular gasket is supported by a gasket retainer.

13. The rail car of claim 9 in which each of said D-shaped elongated tubular gaskets is adapted to be supported in a reversely turned gasket flange formed on each of said doors.

14. The rail car of claim 13 in which each of said D-shaped elongated tubular gaskets is adapted to be compressed by engagement with a gasket engaging finger mounted on each of said rail doors when said doors come together to close said opening.

15. The rail car of claim 9 in which at least one said brush seal located at the top of said door opening is mounted on said doors and its bristles engage said rail car above said door opening.

16. The rail car of claim 9 in which said brush seal located at the bottom of said door opening is mounted on said rail car and said bristles engage said door.
